(19) United States
(12) Patent Application Publication
(10) Pub. No.: US 2026/0148165 A1
(43) Pub. Date: May 28, 2026

(54) LOCAL ARTIFICIAL INTELLIGENCE (AI) INTERACTION AND ORCHESTRATION DEVICE AND A METHOD THEREOF

(71) Applicant: Secufusion Inc, Irving, TX (US)

(72) Inventor: Raghuveer Boinapalli, Irving, TX (US)

(21) Appl. No.: 19/399,839

(22) Filed: Nov. 25, 2025

Related U.S. Application Data
(60) Provisional application No. 63/724,767, filed on Nov. 25, 2024.

(51) Int. Cl. G06Q 10/0631

(52) U.S. Cl. CPC G06Q 10/06316

(57) ABSTRACT

In an embodiment, a local artificial intelligence (AI) interaction and orchestration device is disclosed. The device includes a processor and memory storing instructions for executing a smart agent configured to receive a task specification from a user input, sensor signal, programmatic event, or API call. The smart agent may determine whether the task may be executed locally based on the task specification, device execution capability, and user-specific enterprise policies. When the task is locally executable, the smart agent may decompose the task into subtasks and select corresponding local or remote AI agents, language models, or tool interfaces from an access-controlled capability registry. When the task is not executable locally, the smart agent may transmit the task specification to a remote master agent configured to select authorized backend AI resources, execute the task, and return an output for user delivery.

### TECHNOLOGICAL FIELD OF THE INVENTION

The present invention pertains generally to artificial intelligence (AI) systems, and more specifically relates to systems and methods of orchestrating execution of AI-driven tasks across local and remote computing environments.

### BACKGROUND OF THE INVENTION

Artificial intelligence (AI) technologies have increasingly been adopted by enterprises to enhance productivity, automate workflows, and enable intelligent interactions with enterprise systems. Early deployments commonly relied on generalized, commercially available large language model (LLM) platforms such as Microsoft Copilot and ChatGPT. However, as enterprises expanded their use of AI across diverse departments and business functions, several shortcomings inherent in existing solutions became apparent.

One challenge stems from the fact that generalized AI systems lack awareness of enterprise-specific processes, domain knowledge, and access limitations. Many enterprise tasks rely on privileged or sensitive data; yet existing AI models may not incorporate robust, role-based access control mechanisms. As a result, conventional systems risk exposing confidential information by either over-permitting responses or failing to restrict task execution based on employee entitlements. Furthermore, many enterprise agents or models may be trained on privileged datasets, and existing systems do not adequately enforce authorization boundaries when these agents operate within shared corporate environments.

Another issue arises from impersonation requirements. In many enterprises, AI models must take actions on behalf of a user or access back-end systems that enforce strict identity control. Current AI frameworks do not provide reliable mechanisms to propagate user identity, authenticate task requests, or ensure that backend actions performed by AI agents adhere to the user's access privileges. This results in inconsistent access enforcement, potential unauthorized system activity, and gaps in auditability.

As organizations expand their AI adoption, they increasingly deploy a large number of small, task-specific models or “agents” to handle specialized workflows, information retrieval functions, or generative tasks. Existing AI orchestration frameworks are not designed to efficiently manage or coordinate these heterogeneous agents. Conventional systems lack the ability to intelligently select appropriate agents, divide tasks among them, or aggregate results across multiple models. This leads to operational inefficiencies, duplicative agent behavior, and the inability to support complex, multi-agent problem-solving scenarios.

Enterprises also face significant problems related to discoverability and accessibility of AI agents. With a growing number of models deployed across departments, end users often cannot determine which agent is capable of performing a given task. Current interfaces do not provide effective mechanisms for discovering locally available models, remotely hosted agents, or APIs exposed by enterprise systems. As a result, AI capabilities become fragmented and underutilized.

Another challenge arises from the emergence of powerful AI-capable endpoint devices, such as smartphones, tablets, and modern laptops. These devices can execute local models, but existing AI ecosystems do not provide coordinated decision-making between local execution and cloud-executed models. Current systems lack a unified mechanism to determine whether a task should be performed locally or remotely based on device capability, policy restrictions, or resource availability. This results in suboptimal latency, inconsistent performance, and unnecessary backend load.

Finally, existing art does not adequately support context-aware AI interaction. When AI models operate within web browsers or other local environments, conventional systems fail to extract meaningful context from browser history, current page content, device activity, or user interaction patterns. Without such context, AI models produce generic outputs that are not aligned with the user's current workflow, leading to reduced relevance and diminished utility.

Accordingly, there is need for enterprise AI systems having robust access control, clear impersonation mechanisms, coordinated multi-agent orchestration, agent discoverability, local-remote execution optimization, and context-aware task interpretation.

### DESCRIPTION OF THE RELATED ART

India Patent Application No. 202511082519 discloses an enterprise-focused agentic AI engine that supports secure hybrid inferencing and contextual grounding. The disclosed system includes an agent orchestration layer configured to dynamically route incoming queries to one or more autonomous agents based on predefined role definitions, enabling the agents to operate individually or collaboratively through logic that supports parallel task execution and synthesis of final results. The system further includes an enterprise contextual memory module configured to store and retrieve structured and unstructured organizational data such that agent outputs are grounded in enterprise context. A hybrid inferencing engine is provided to selectively route inference requests either to an internal enterprise-controlled language model or to an external public language model, based on configurable rules, query characteristics, and data sensitivity. Additionally, an access control module enforces fine-grained, role-based, and policy-driven permissions governing data retrieval and output generation.

German Utility Model No. DE202025100771U1 describes a system for orchestrating LLM-driven agents across multi-domain workflows. The system includes an orchestration module that dynamically assigns tasks based on contextual understanding, workload balance, and agent expertise, and a multi-agent collaboration module enabling communication among agents to exchange information, reduce redundancies, and optimize execution. A real-time decision-making module uses machine-learning algorithms to evaluate task priority, user intent, and operating conditions for adaptive workflow customization. A gain-learning optimization module refines delegation rules using historical data and feedback. The system further includes a monitoring and analysis module providing real-time performance insights and visual dashboards, an integration layer supporting interoperability with enterprise systems, APIs, and databases, and a security and compliance module implementing access control, encryption, and regulatory compliance monitoring to ensure secure AI operations.

All aforementioned patents and publications are incorporated herein by reference.

While the above prior art references discloses various systems and methods for orchestrating LLM-driven agents, however, the said prior art references fail to provide enterprise AI systems with robust access control, clear impersonation mechanisms, coordinated multi-agent orchestration, agent discoverability, local-remote execution optimization, and context-aware task interpretation.

### SUMMARY OF THE INVENTION

In an embodiment of the present disclosure, a local artificial intelligence interaction and orchestration device (smart agent) is described. The device may include a processor and a memory that stores instructions for executing a smart agent. In some embodiments, the device may be realized as a software implementation operating either as a module or as a standalone application within a host environment, including but not limited to a browser, a laptop, a desktop system, or a mobile computing device. The smart agent may receive a task specification from various triggers such as user input, sensor signals, programmatic events, or API calls. The smart agent may evaluate whether the task may be executed locally by considering the task's nature, the device's execution capability, and access policies associated with the user. When local execution may be possible, the smart agent may decompose the task into subtasks and select suitable local or remote AI agents, language models, or tool interfaces (in this disclosure, tool interfaces may include Application Programming Interfaces (APIs) or Interface protocols) from a capability registry filtered using enterprise policies. When local execution may not be feasible, the task specification may be transmitted to a remote master agent that may select authorized backend resources, activate them for execution, and return the processed output for user delivery.

In an embodiment, the master agent may further provide backend AI agents, language models, or tool interfaces with user-specific access credentials or limitations derived from enterprise policies. This may allow the master agent to enforce privilege-restriction operations so that backend components act only within the authorized scope of the requesting user.

In an embodiment, privilege-restriction enforcement by the master agent may include generating ephemeral access tokens. These tokens may be scoped to the requesting user's enterprise privileges and may limit backend actions to short-lived, policy-compliant operations.

In an embodiment, the local device may determine a task context based on contextual data such as local device signals, browser activity, user history, or system state. The task context may influence critical stages of processing, including deciding whether local execution is feasible, determining how the task may be decomposed into subtasks, or selecting appropriate AI agents, language models, or tools.

In an embodiment, the local device signals used for determining task context may include hardware and software state indicators, browser usage behavior, stored user interaction history, or device capability indicators such as available processor or memory resources, or system-level execution restrictions.

In an embodiment, determining task context may further include monitoring browser tabs, content displayed within applications, active software processes, or recent user interaction patterns weighted by recency.

In an embodiment, the smart agent may obtain subtask-level outputs produced by selected AI agents, models, or tools and may combine them into a consolidated task result suitable for user presentation.

In an embodiment, the consolidated task result may include structured output annotated with provenance indicators that identify which AI agents, models, or tools contributed to the produced result, thereby supporting transparency and traceability.

In an embodiment, determining whether a task may be executed locally may include computing a device-capability score based on metrics such as memory availability, processor utilization, neural accelerator presence, or energy constraints.

In an embodiment, the master agent may determine whether a task requires cooperation among multiple backend agents, decompose the task when multi-agent collaboration may be necessary, and orchestrate delegation across applicable backend resources.

In an embodiment, the local capability registry may be dynamically updated based on changes in enterprise policies, availability of new local models, or removal of access rights to previously authorized models or tools.

In an embodiment, entries of the local capability registry may reference AI agents, language models, or tool interfaces that may execute either on the local device or remotely via authorized enterprise channels.

In an embodiment, the smart agent may classify incoming tasks into categories such as workflow automation, information retrieval, generative response generation, or multi-agent reasoning to determine an appropriate processing path.

In an embodiment, the master agent may coordinate execution across on-premise enterprise infrastructure and cloud-hosted AI resources based on routing policies defined by the enterprise.

In another embodiment, a method of executing a task using the local device is described. The method may include receiving a task specification via one of: an input from a user, a sensor-generated signal, a programmatic event, or an application programming interface (API) call; and determining whether the task specified by the task specification is executable locally, based on the task specification, an execution capability of the local AI interaction and orchestration device, and an execution policy associated with the user. When the task specified by the task specification is executable locally, the method may further include decomposing the task specification into a plurality of subtasks; and for each of the plurality of subtasks, selecting one or more local or remote AI agents, language models, or tool interfaces from a local capability registry, wherein the local capability registry is filtered according to enterprise access-control policies associated with the user. When the task specification is not executable locally, the method may further include transmitting the task specification to a remote computing platform executing a master agent. The master agent may be configured to: select, based on an enterprise directory, an authorized set of AI agents, language models, or tool interfaces available to the user for performing the task corresponding to the task specification; activate the selected AI agents, language models, or tool interfaces to execute the task specified by the task specification; and transmit an output associated with the executed task specification to the smart agent for user delivery.

In an embodiment, a non-transitory computer-readable medium may store instructions that, when executed, perform the operations of receiving task specifications, evaluating local executability, decomposing tasks, performing agent selection, delegating tasks to a master agent when appropriate, and delivering results back to the smart agent.

### BRIEF DESCRIPTION OF THE DRAWINGS

Having thus described example embodiments of the invention in general terms, illustrative embodiments of the present invention are described herein and serve to explain principles of the disclosed embodiments with reference to the accompanying drawings, which are not necessarily drawn to scale. It is to be understood, however, that these figures are presented for purposes of illustration only, not for defining limits of relevant inventions, and wherein:

FIG. 1 is a block diagram of a system for executing a task using a local artificial intelligence (AI) interaction and orchestration device, in accordance with some embodiments of the invention.

FIG. 2 is a block diagram of the local device showing one or more modules, in accordance with some embodiments of the present invention.

FIG. 3 is a block diagram of an example architecture of a distributed artificial intelligence (AI) interaction and orchestration environment, in accordance with some embodiments.

FIG. 4 illustrates a flowchart of a method of executing a task using a local artificial intelligence (AI) interaction and orchestration device, in accordance with some embodiments.

FIG. 5 illustrates an exemplary computing system that may be employed to implement processing functionality for various embodiments, in accordance with some embodiments of the present invention.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

The present disclosure relates to a local artificial intelligence (AI) interaction and orchestration device and method thereof. The device may operate on or as part of an endpoint such as a browser environment, a desktop system, a laptop system, or a mobile computing platform. The device may implement a smart agent configured to process task specifications and orchestrate execution using local or remote AI resources. The architecture may function in conjunction with a backend master agent.

The smart agent may receive a task specification when triggered by various forms of input, including user interactions, sensor events, programmatic signals, or API calls. Upon receiving the task specification, the smart agent may analyse device performance characteristics, enterprise policy constraints, and the content of the specification to determine whether local execution is feasible. Such analysis may involve evaluating processor load, memory availability, neural-accelerator or neural-processing capabilities, or energy constraints. The determination process may also include assessing whether the user is permitted to invoke particular AI agents or tools, based on access-control rules obtained from an enterprise directory or local policy cache.

When local execution is permitted, the smart agent may decompose the task specification into subtasks. Decomposition may utilise semantic parsing, intent extraction, or workflow-mapping models. For each subtask, the agent may consult a local capability registry that may contain references to locally available language models, device-resident AI agents, and remotely accessible tools or models exposed through enterprise-approved channels. The registry may be filtered based on user privileges, ensuring that only capabilities authorized for the user are selectable.

The smart agent may obtain contextual data to refine task interpretation. Contextual signals may include local device telemetry, active application information, browser page content, user interaction patterns, or recently accessed resources. In browser-based deployments, the agent may extract contextual cues from visited webpages or tab metadata (as described in the uploaded document's browser-based operation section) . These signals may guide the decomposition process and influence the selection of appropriate AI agents or tools.

Once subtasks are executed, the smart agent may retrieve outputs from the invoked agents or models and may merge them into a consolidated result. Such merging may involve data alignment, conflict resolution, summarization, or synthesis operations. The consolidated output may include provenance indicators identifying which backend or local components contributed to each portion of the result.

When local execution is unsuitable, the device may forward the task specification and associated context to a remote master agent. The master agent may determine user-authorized backend capabilities, select relevant AI agents or models, and orchestrate backend execution. It may apply impersonation or privilege-restriction controls by generating user-scoped access credentials or ephemeral tokens, ensuring backend components act only within authorized boundaries. The master agent may also perform further subtask decomposition when multi-agent cooperation is required, coordinating execution across heterogeneous backend systems, including cloud-hosted and on-premise AI resources, consistent with the orchestration workflow shown in the backend diagram.

After processing, the master agent may return an output suitable for presentation by the smart agent, enabling a seamless, context-aware AI interaction on the local device.

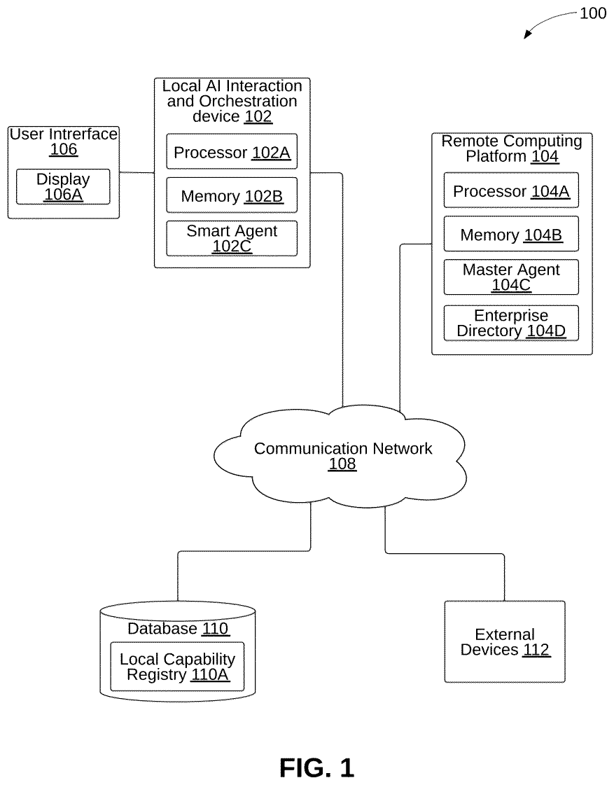

Turning now to FIG. 1, which is a block diagram of the system 100 for executing a task using a local artificial intelligence (AI) interaction and orchestration device, in accordance with some embodiments of the invention. In one embodiment, the system 100 is implemented on a local AI interaction and orchestration device 102 (also referred to as local device 102) that may be implemented, for example, as a smartphone, tablet, etc.

Further, the system 100 includes a database 110 which may store, for example, local capability registry 110A. In some embodiments, the local capability registry 110A may be stored within a data storage resource integrated into the local device 102 itself. The local device 102 is a computing device having data processing capability. In particular, the local device 102 has the capability for executing a task by orchestrating a plurality of AI agents. Examples of the local device 102 may include, but are not limited to a desktop, a laptop, a notebook, a netbook, a tablet, a smartphone, a mobile phone, an application server, a web server, or the like.

Additionally, the local device 102 is communicatively coupled to an external device 112 for sending and receiving various data. Examples of the external device 112 may include, but are not limited to, a remote server, digital devices, and a computer system. The local device 102 connects to the external device 112 over a communication network 108. The communication network 108 may be a wired connection, for example via Universal Serial Bus (USB). A computing device, a smartphone, a mobile device, a laptop, a smartwatch, a personal digital assistant (PDA), an e-reader, and a tablet are all examples of the external device 112. For example, the communication network 108 may be a wireless network, a wired network, a cellular network, a Code Division Multiple Access (CDMA) network, a Global System for Mobile Communication (GSM) network, a Long-Term Evolution (LTE) network, a Universal Mobile Telecommunications System (UMTS) network, a Worldwide Interoperability for Microwave Access (WiMAX) network, a Dedicated Short-Range Communications (DSRC) network, a local area network, a wide area network, the Internet, satellite or any other appropriate network required for communication between the local device 102 and the database 110, and the external device 112.

In some embodiments, the system 100 further implements a remote computing platform 104, which implements a master agent 104C, which may be configured to select and activate authorized set of AI agents, language models, or tool interfaces, to execute the task specified by task specification.

The local device 102 is configured to perform one or more operations, that may include receiving a task specification via one of: an input from a user, a sensor-generated signal, a programmatic event, or an application programming interface (API) call. The operations may further include determining whether the task specified by the task specification is executable locally, based on the task specification, an execution capability of the local AI interaction and orchestration device, and an execution policy associated with the user. when the task specified by the task specification is executable locally, the operations may include decomposing the task specification into a plurality of subtasks, and for each of the plurality of subtasks, selecting one or more local or remote AI agents, language models, or tool interfaces from a local capability registry. The local capability registry may be filtered according to enterprise access-control policies associated with the user. In some embodiments, the local device 102 may implement a smart agent 102C which may perform the operations.

When the task specification is not executable locally, the operations may include transmitting the task specification to a remote computing platform 104 executing a master agent 104C. The master agent 104C may be configured to perform one or more operations that may include selecting, based on an enterprise directory, an authorized set of AI agents, language models, or tool interfaces available to the user for performing the task corresponding to the task specification. The operations may further include activating the selected AI agents, language models, or tool interfaces to execute the task specified by the task specification, and transmitting an output associated with the executed task specification to the smart agent for user delivery.

To perform the above functionalities, the local device 102 includes a processor 102A and a memory 102B. The memory 102B is communicatively coupled to the processor 102A. The memory 102B stores a plurality of instructions, which upon execution by the processor 102A, causes the processor 102A to perform the above functionalities. The system 100 further includes a user interface 106 which may be further implemented on a display screen 106A. Examples of the user interface 106 may include, but are not limited to a display, keypad, microphone, audio speakers, vibrating motor, LED lights, etc. The user interface 106 is configured to receive an input from the user and also display an output of the computation performed by the local device 102. The user interface 106 may either be integrated within the local device 102 or may be implemented as a separate module.

Similarly, to perform the operations of the master agent 104C, the remote computing platform 104 may include a processor 104A and a memory 104B. The memory 104B is communicatively coupled to the processor 104A. The memory 104B stores a plurality of instructions, which upon execution by the processor 104A, causes the processor 104A to perform the above functionalities.

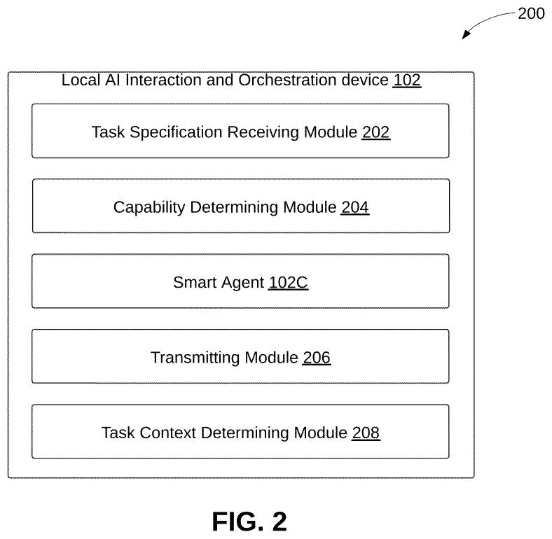

Referring now to FIG. 2, a block diagram of the local device 102 showing one or more modules is illustrated, in accordance with some embodiments of the present invention. In some embodiments, the local device 102 implements a task specification receiving module 202, a capability determining module 204, the smart agent 102C, a transmitting module 206, and a task context determining module 208.

The task specification receiving module 202 may be configured to receive a task specification via one of multiple pathways that may operate concurrently or asynchronously within the local device. In one implementation, the module 202 may receive the task specification in response to a direct user input, for example, text entry, voice instruction, gesture interaction, or a graphical interface selection. In another implementation, the module 202 may receive the task specifications triggered by sensor-generated signals, which may include device-level events, for example, motion detection, ambient condition changes, biometric sensor outputs, or system notifications indicating that a contextual operation is required. In yet another implementation, the module 202 may receive the task specification generated by a programmatic event within the local device 102 such that an application, service, or scheduled workflow may emit a structured request for autonomous task execution. Further, in another implementation, the module 202 may receive the task specifications through an application programming interface (API) call. The API call may cause external systems, enterprise applications, browser extensions, scripts, or backend services to transmit well-formed task specifications to the smart agent 102C.

The capability determining module 204 may be configured to analyze whether a received task specification should be executed on the local device 102, based on evaluation of various factors comprising: the task specification, an execution capability of the local device 102, and an execution policy associated with the user. In particular, the module 204 may parse the task specification to identify the computational intensity of the requested operation, the types of AI agents or language models required, and whether the subtasks derived from the specification align with the functional capabilities available at the endpoint. Further, the module 204 may analyze an execution policy associated with the user; the execution policy may define role-based constraints, permissible model categories, or security-limited actions that the user is authorized to invoke. The module 204 may further determine whether executing the task on the local device 102 would maintain compliance with enterprise policies and whether the smart agent 102C has sufficient functional capability to complete the task (without backend support). The evaluation may be further based on the presence of locally stored or locally deployable AI models, available tool interfaces, and the ability of the smart agent to orchestrate multiple subtasks within the device environment.

In some embodiments, in order to determine whether the received task specification should be executed on the local device 102 or not, the module 204 may compute a device-capability score indicative of the current ability of the local device 102 to process AI-driven workloads. In some embodiments, the said score may be derived from one or more operating parameters, including: a memory availability, a processor load, a presence and readiness of neural-accelerator hardware, or an energy level constraints, that influence computing operations. For example, the memory availability may be analyzed via one of: system-level telemetry, buffer allocations, or memory fragmentation indicators. The processor utilization may be analyzed through historical and real-time CPU scheduling metrics. In scenarios where the local device 102 includes specialized accelerators, the module 204 may evaluate accelerator occupancy, thermal limits, or model-compatibility requirements before deciding whether accelerator-backed execution is feasible. Further, energy level constraints may include battery percentage, power-saving modes, or thermal throttling behavior that could limit local performance. The module 204 may combine the above factors into a weighted score indicative of a near-term capability of the local device 102 to execute the task locally. When the weighted score meets or exceeds a predefined threshold, the module 204 may select local execution; otherwise, the module 204 may determine that the task should be delegated to the remote computing platform 104 for backend execution.

Once the capability determining module 204 determines that the received task specification may be executed locally, the smart agent 102C may perform one or more operations to fulfil the requested functionality using resources available on the endpoint device. In particular, the smart agent 102C may classify the incoming task into one of several operational categories. For example, the operational categories may include a workflow automation category, an information retrieval category, a generative response generation category, or a multi-agent reasoning category. For example, the categorization may be performed based on linguistic analysis, pattern detection, metadata extraction, or semantic clustering. Each subtask may correspond to a processing objective, such as: data extraction, transformation, model invocation, or integration of intermediate outputs. In order to perform decomposition, the smart agent 102C may apply rule-based models, machine-learned decomposition models, or context-conditioned heuristics, so that each subtask is well-defined and can be delegated to an suitable local AI agent.

Once the task is decomposed into subtasks, the smart agent 102C may refer the local capability registry 110A to determine which local AI agents, language models, or tool interfaces may be authorized for handling each subtask. The local capability registry 110A may include entries referencing both locally available capabilities and remotely accessible resources exposed through enterprise-approved channels. The said entries may further include functionality descriptors, performance characteristics, model compatibility information, and trust or privilege attributes. Further, the registry 110A may be filtered dynamically so that only those capabilities permitted under enterprise access-control policies associated with the user are selectable. For example, the said filtering may apply role-based restrictions, departmental scopes, sensitivity classifications, or time-bounded permissions.

In some embodiments, the registry 110A may be updated in real-time or at scheduled intervals in response to at least one of: changes in enterprise policy, deployment of new models, or removal of deprecated or revoked capabilities. As such, the smart agent 102C is able to operate with an up-to-date representation of the available AI ecosystem.

In some embodiments, for each subtask, the smart agent 102C may select one or more suitable AI agents, language models, or tool interfaces based on factors including: required model capacity, latency considerations, local compute availability, or proximity to relevant data sources. Upon execution of the selected capabilities, the agent 102C may obtain subtask outputs through synchronous or asynchronous retrieval mechanisms. The said outputs may represent raw model responses, structured data, analytical summaries, or intermediate artifacts generated by backend or device-resident components. The smart agent 102C may further aggregate the subtask outputs into a consolidated task result by executing operations including: ranking, merging, summarization, contextual harmonization, or conflict resolution.

The consolidated result may be represented in a structured format and may include provenance indicators that identify which AI agents, language models, or tool interfaces contributed to each portion of the output. It should be noted that the provenance indicators may be configured to assist in auditability, explainability, quality verification, and compliance tracking. The final aggregated result may then be prepared for delivery to the user in a form appropriate for the requesting interface or workflow.

Once the capability determining module 204 determines that the received task specification cannot be executed locally, the transmitting module 206 may transmit the task specification to the remote computing platform 104 executing a master agent 104C.

The master agent 104C may be configured to orchestrate backend execution of the task. Upon receiving the task specification and any associated context from the smart agent, the master agent 104C may reference the enterprise directory 104D to identify an authorized set of AI agents, language models, or tool interfaces that the requesting user is permitted to access. The enterprise directory 104D may store role-based attributes, group memberships, department-level permissions, resource scoping rules, and fine-grained access policies. By correlating the user's identity with these attributes, the master agent 104C may generate a filtered set of backend capabilities suitable for task execution. Once authorized capabilities are identified, the master agent 104C may activate one or more of these components (i.e., AI agents, language models, or tool interfaces) to execute the task specified by the task specification. For example, the activation may include allocating compute resources, establishing secure communication channels, supplying required input parameters, or instantiating a runtime environment tailored to each selected capability. Upon completion of backend processing, the master agent 104C may collect the output from the said activated components, normalize the results into a common representation, and transmit the processed output to the smart agent 102C for user delivery.

In some embodiments, the master agent 104C may further provide the activated components with user-specific access credentials or access limitations derived from the enterprise directory, so that the backend execution complies with enterprise access-control policies. The said access credentials may encode contextual security attributes, for example, datasets that the user can access, operations that the user is permitted to perform, or system boundaries that are to be applied. In some embodiments, the master agent 104C may generate ephemeral access tokens that are scoped to the enterprise privileges of the user. These tokens may be short-lived, cryptographically signed, and restricted to a narrow set of backend operations, so as to prevent privilege escalation and ensure that each backend component performs actions only within the boundaries authorized for the user.

In some scenarios, the master agent 104C may determine that completing the task specification may require cooperation among multiple backend AI agents. The said determination may be based on the complexity of the task, the interdependencies of required operations, and the functional diversity of available backend capabilities. As such, upon determining that multi-agent cooperation is required, the master agent 104C may decompose the task specification into a plurality of subtasks suitable for distributed execution. The decomposition, for example, may be based on workflow analysis, dependency graph construction, semantic segmentation, or model-guided partitioning. After defining the subtasks, the master agent 104C may orchestrate delegation of the subtasks to the one or more backend AI agents. It may be noted that the backend AI agents may operate across heterogeneous cloud or on-premise environments. therefore, the orchestration may include scheduling subtask execution, ordering subtasks based on dependency rules, aggregating intermediate outputs, resolving conflicts, and monitoring execution states. By way of multi-agent coordination, the master agent 104C may enable completion of the overall task efficiently, securely, and in accordance with enterprise policies.

In some embodiments, additionally, a task context determining module 208 may be configured to analyze a task specification in conjunction with contextual information obtained from the local device 102 in order to derive a task context. The task context may be applied for subsequent decision-making performed by the smart agent 102C. The module 208 may obtain contextual data from one or more sources, including local device signals, browser activity, user history, or system state. For example, local device signals may include system-level indicators including processing load, memory availability, thread occupancy patterns, active network interfaces, or energy state conditions that reflect the operational readiness of the local device 102. Further, browser activity may include recently visited webpages, active webpage metadata, form interaction patterns, or temporal browsing sequences that offer insight into the user's ongoing intent. Furthermore, user history may include application usage patterns, previously issued task specifications, local preference files, saved user profiles, or historical interaction logs stored on the endpoint. Moreover, system state may encompass factors such as the presence of active background services, the availability of peripheral devices, cached authentication tokens, or the execution status of local workflows.

In some embodiments, determining the task context may include continuous or event-driven monitoring of browser tabs, page content, active applications, locally running processes, or recency-weighted user interactions. As will be understood, by way of monitoring browser tabs and page content, the module 208 may infer which digital resources the user is actively engaged with or which information domains are most relevant to the task. Similarly, by way of monitoring active applications or running processes, the module 208 may detect complementary operations, potential conflicts, or opportunities for workflow integration. Further, by monitoring recency-weighted interaction, the 208 may be able to prioritize more recent contextual signals over older ones to generate a context representation reflective of the current state and objectives of the user.

The derived task context may then be applied by the smart agent 102C to influence various subsequent operations. For example, firstly, the task context may be applied for determining whether the task specified by the task specification is executable locally. As such, device capability indicators (e.g., processor utilization or memory conditions) may indicate local execution to be less favorable. Further, task-specific context may indicate that the required data resides on a remote service, because of which backend execution may be more suitable. Secondly, the task context may be applied in the process of decomposition of the task specification into subtasks. This is because the task context may indicate user intent, domain-specific content, or dependencies between operations. Thirdly, the task context may influence the selection of local or remote AI agents, language models, or tool interfaces from the local capability registry 110A or enterprise directory 104D, respectively, by pointing to models or capabilities that are best suited to the detected domain, user preferences, system conditions, or relevant content.

Therefore, the module 208 may support context-aware orchestration, allowing the smart agent 102C to adapt its internal decision-making, improve task relevance, and optimize the selection and execution of AI-driven subtasks in accordance with the user's environment and the capabilities of the endpoint device.

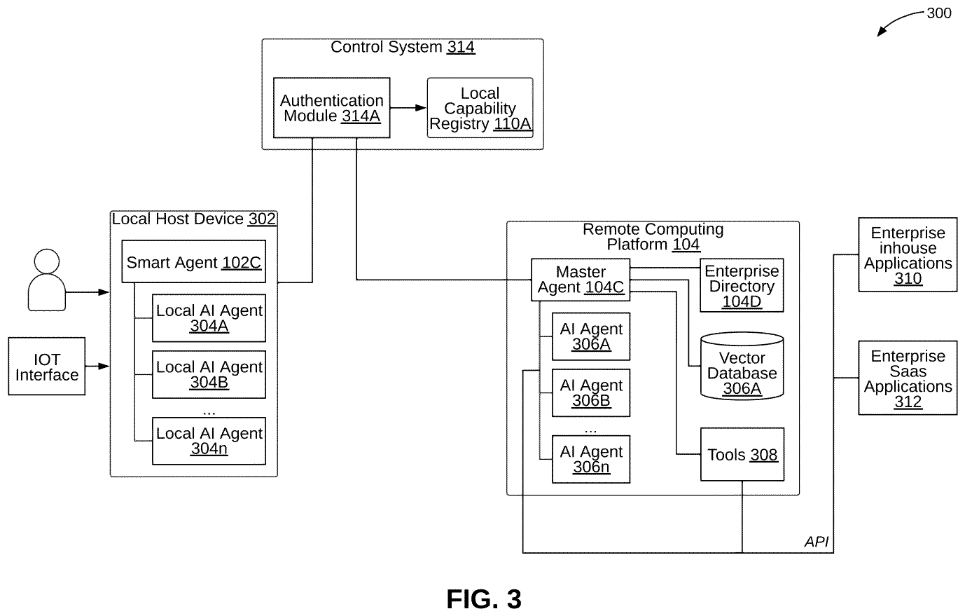

Referring now to FIG. 3, a block diagram of an example architecture 300 of a distributed artificial intelligence (AI) interaction and orchestration environment is illustrated, in accordance with some embodiments. FIG. 3 is explained in conjunction with FIG. 1 and FIG. 2.

As shown in FIG. 3, the architecture 300 includes the smart agent 102C operating on a local host device 302 (e.g., the local device 102) that may interact with the remote computing platform 104 via enterprise-controlled infrastructure. The local host device 302 may execute the smart agent 102C and a set of local AI agents 304A, 304B, . . . 304n (hereinafter, collectively referred to as local AI agents 304). The local AI agents 304 may be capable of handling device-native AI workloads. The local host device 302 may receive task specifications originating from a user, a connected IoT interface, or other system triggers. The local host device 302 may then determine whether such tasks may be executed locally or require delegation to backend components. Each local AI agent 304 may represent a discrete model or processing unit capable of performing specialized subtasks. The smart agent 102C, as described above, may selectively activate one or more of the local AI agents 304, based on local execution capability, device state, and access policies retrieved from the enterprise ecosystem.

The architecture 300 may further implement a control system 314 that may operate independently of both the local host device 302 and the remote computing platform 104 to manage authentication and authorization workflows. The control system 314 may include an authentication module 314A for validating user identities, device trust levels, or session tokens. The authentication module 314A may further interact with the local capability registry 110A that may store authorized mappings of AI agents, language models, or tool interfaces available to each user role. The local capability registry 110A may be updated dynamically by the enterprise to reflect new access rights, additional AI models, or retired components. As such, the local capability registry 110A may provide for that both local and remote orchestration behaviors are compliant with enterprise policies.

The remote computing platform 104 may host the master agent 104C that may perform backend orchestration when the local host device 302 determines that a task cannot be efficiently or securely processed on the device 302. The master agent 104C may then coordinate with multiple backend AI agents 306A, 306B, . . . 306n (also referred to as backend AI agents 306), that may include domain-specific models, large-scale inference engines, or specialized analytic tools. Further, the remote computing platform 104 may include the enterprise directory 104D. The directory 104D may store role definitions, group memberships, policy configurations, and resource-access constraints that may be used to determine which backend capabilities may be activated for a particular user. Furthermore, a vector database 306A (or other knowledge-indexing structures) may be implemented in the remote computing platform 104. The vector database 306A may store embeddings, enterprise data artefacts, or semantic vectors enabling the backend agents to perform contextual retrieval and reasoning for complex tasks, as already described above.

The remote computing platform 104 may include tools 308 that may execute data retrieval, workflow execution, compliance evaluation, or enterprise-specific operations. As such, the above-mentioned tools 308 may coordinate with enterprise in-house applications 310 or cloud-hosted Software-as-a-Service (SaaS) platforms 312 through one or more APIs, thereby enabling the master agent 104C to perform actions. For example, the actions performed by the master agent 104C may include querying business systems, generating reports, orchestrating multi-step business workflows, or executing policy-restricted operations on behalf of the user. the outputs generated by backend agents 306 may be aggregated by the master agent 104C and communicated to the smart agent 102C for further processing, normalization, or delivery to the user.

Thus, the architecture 300 enables the smart agent 102C (implemented locally) to collaborate with a remote orchestration layer, and manage enterprise authentication, capability governance, and multi-agent AI resources. As such, the architecture 300 enables seamless hybrid execution, secure access control, and context-aware task processing across device-level and cloud-level compute environments.

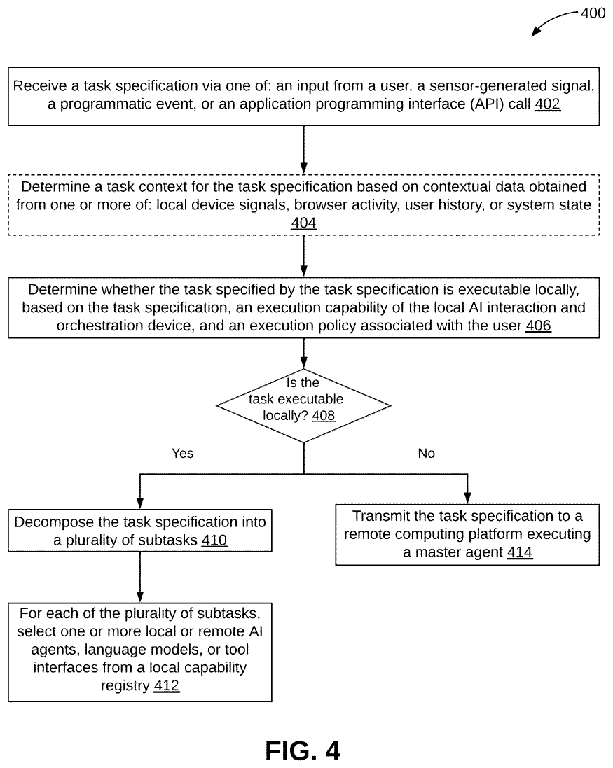

FIG. 4 illustrates a flowchart of a method 400 of executing a task using a local artificial intelligence (AI) interaction and orchestration device 102, in accordance with some embodiments. FIG. 4 is explained in conjunction with FIGS. 1-3.

At step 402, a task specification may be received via one of multiple pathways that may operate concurrently or asynchronously within the local device 102. For example, the pathways may include a direct input from the user, a sensor-generated signal originating from device-connected hardware, a programmatic event triggered by a locally running application or workflow, or a call received through an application programming interface. The task specification may include an explicit request, a natural-language instruction, a structured command, or metadata that identifies the expected operation.

In some embodiments, at step 404, a task context associated with the task specification may be determined. The context may be derived from contextual data obtained from one or more sources including local device signals, browser activity, user history, or system state. As described above, the local device signals may include hardware-usage indicators, memory conditions, or current networking state, while browser activity may include active pages or recent user interactions; user history may include previously issued requests, frequently accessed content, or stored organizational preferences; and system state may include active applications or background processes. This context may enable the smart agent 102C with a more complete understanding of the conditions under which the requested task is being issued.

At step 406, it may be determined that whether the task specified by the task specification is executable locally. For example, the determination may be based on the characteristics of the task itself, the execution capability of the local AI interaction and orchestration device 102, and an execution policy associated with the user. The previously determined task context may influence this evaluation; for example, contextual indicators such as resource availability, network connectivity, or the presence of sensitive data may alter whether local execution is acceptable or whether backend processing is preferable. In some embodiments, in order to determine whether the task specification is executable locally, at step 406, further a device-capability score may be computed based on at least one of: memory availability, processor utilization, neural-accelerator presence, or energy constraints. The determination at step 406 may, therefore, be performed based on the device-capability score.

As such, a check may be performed, at step 408, to check whether the task is executable locally or not. If, at step 408, it is determined that the task is executable locally, then the method 400 may proceed to step 410 (“Yes” path).

At step 410, the smart agent 102C may decompose the task specification into a plurality of subtasks. It should be noted that the present disclosure encompasses scenarios in which decomposition may yield only a single task, rather than the plurality of subtasks; hence, in such scenarios, the terms subtask(s) may refer to that single resulting task. The decomposition may follow semantic analysis, pattern-based segmentation, workflow-mapping procedures, or other AI-driven decomposition methods.

At step 412, for each subtask, the smart agent 102C may select one or more local or remote AI agents, language models, or tool interfaces from the local capability registry 110A. The local capability registry 110A may contain entries representing device-resident capabilities as well as remotely accessible capabilities exposed through enterprise-approved channels. The selection process may be influenced by the task context as well as access-control policies derived from enterprise governance rules.

In some embodiments, the local capability registry 110A may be dynamically updated based on changes to enterprise policy, newly available local models, or revoked access rights. The local capability registry 110A may include entries referencing AI agents, language models, or tool interfaces executable on the local device or remotely through enterprise-approved channels.

In some embodiments, the smart agent 102C may additionally obtain, for the plurality of subtasks, subtask outputs from the selected one or more local or remote AI agents, language models, or tool interfaces, and then aggregate the subtask outputs into a consolidated task result for presentation to the user. The consolidated task result may include structured output annotated with provenance indicators identifying contributing AI agents, language models, or tool interfaces.

In some embodiments, at step 412, the smart agent 102C may further classify incoming tasks into categories comprising: a workflow automation category, an information retrieval category, a generative response generation category, or a multi-agent reasoning category.

If, at step 408, it is found that the task specification is not executable locally, then, the method may proceed to step 414 (“No” path).

At step 414, the smart agent 102C may transmit the task specification, along with any relevant contextual metadata, to the remote computing platform 104 executing the master agent 104C. The master agent 104C may thereafter perform backend orchestration, agent selection, and task execution operations on behalf of the local device. For example, the master agent 104C may select, based on the enterprise directory 104D, an authorized set of AI agents, language models, or tool interfaces available to the user for performing the task corresponding to the task specification. Further, the master agent 104C may activate the selected AI agents, language models, or tool interfaces to execute the task specified by the task specification. The master agent 104C may further transmit an output associated with the executed task specification to the smart agent 102C for user delivery.

In some embodiments, the master agent 104C may be configured to provide the activated AI agents, language models, or tool interfaces with user-specific access credentials or access limitations derived from enterprise policies, to enforce privilege-restriction operations. The privilege-restriction operations, for example, may include generating ephemeral access tokens scoped to the user's enterprise privileges.

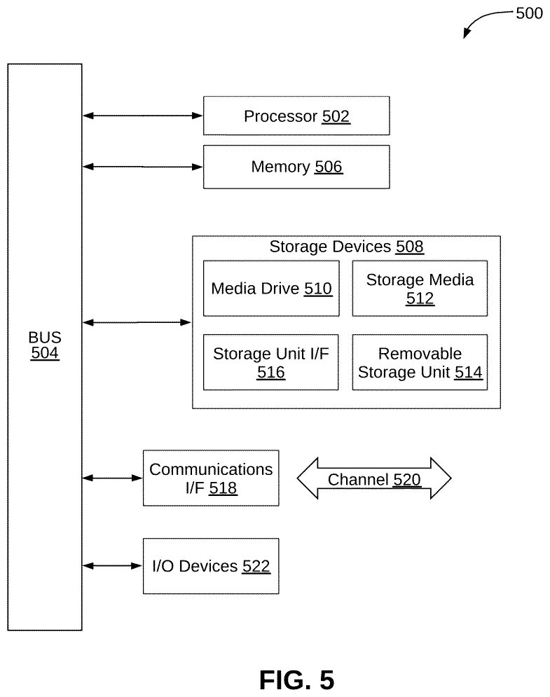

Referring now to FIG. 5, an exemplary computing system 500 that may be employed to implement processing functionality for various embodiments (e.g., as a Single Instruction Multiple Data (SIMD) device, client device, server device, one or more processors, or the like) is illustrated. Those skilled in the relevant art will also recognize how to implement the invention using other computer systems or architectures. The computing system 500 may represent, for example, a user device such as a desktop, a laptop, a mobile phone, personal entertainment device, DVR, and so on, or any other type of special or general-purpose computing device as may be desirable or appropriate for a given application or environment. The computing system 500 may include one or more processors, such as a processor 502 that may be implemented using a general or special purpose processing engine such as, for example, a microprocessor, microcontroller or other control logic. In this example, the processor 502 is connected to a bus 504 or other communication media. In some embodiments, the processor 502 may be an Artificial Intelligence (AI) processor, which may be implemented as a Tensor Processing Unit (TPU), or a graphical processor unit, or a custom programmable solution Field-Programmable Gate Array (FPGA).

The computing system 500 may also include a memory 506 (main memory), for example, Random Access Memory (RAM) or other dynamic memory, for storing information and instructions to be executed by the processor 502. The memory 506 also may be used for storing temporary variables or other intermediate information during the execution of instructions to be executed by processor 502. The computing system 500 may likewise include a read-only memory (“ROM”) or other static storage device coupled to the bus 504 for storing static information and instructions for the processor 502.

The computing system 500 may also include at least one storage devices 508, which may include, for example, a media drive 510 and a removable storage interface. The media drive 510 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 512 may include, for example, a hard disk, magnetic tape, flash drive, or other fixed or removable media that is read by and written to by the media drive 510. As these examples illustrate, the storage media 512 may include a computer-readable storage medium having stored therein particular computer software or data.

In alternative embodiments, the at least one storage devices 508 may include other similar instrumentalities for allowing computer programs or other instructions or data to be loaded into the computing system 500. Such instrumentalities may include, for example, a removable storage unit 514 and a storage unit interface (I/F) 516, such as a program cartridge and cartridge interface, a removable memory (for example, a flash memory or other removable memory module) and memory slot, and other removable storage units and interfaces that allow software and data to be transferred from the removable storage unit 514 to the computing system 500.

The computing system 500 may also include a communications interface (I/F) 518. The communications interface 518 may be used to allow software and data to be transferred between the computing system 500 and external devices 112. Examples of the communications interface 518 may include a network interface (such as an Ethernet or other NIC card), a communications port (such as for example, a USB port, a micro-USB port), Near field Communication (NFC), etc. Software and data transferred via the communications interface 518 are in the form of signals which may be electronic, electromagnetic, optical, or other signals capable of being received by the communications interface 518. These signals are provided to the communications interface 518 via a channel 520. The channel 520 may carry signals and may be implemented using a wireless medium, wire or cable, fiber optics, or other communications medium. Some examples of the channel 520 may include a phone line, a cellular phone link, an RF link, a Bluetooth link, a network interface, a local or wide area network, and other communications channels.

The computing system 500 may further include Input/Output (I/O) devices 522. Examples may include, but are not limited to a display, keypad, microphone, audio speakers, vibrating motor, LED lights, etc. The I/O devices 522 may receive input from a user and also display an output of the computation performed by the processor 502. In this document, the terms “computer program product” and “computer-readable medium” may be used generally to refer to media such as, for example, the memory 506, the at least one storage devices 508, the removable storage unit 514, or signal(s) on the channel 520. These and other forms of computer-readable media may be involved in providing one or more sequences of one or more instructions to the processor 502 for execution. Such instructions, generally referred to as “computer program code” (which may be grouped in the form of computer programs or other groupings), when executed, enable the computing system 500 to perform features or functions of embodiments of the present invention.

In an embodiment where the elements are implemented using software, the software may be stored in a computer-readable medium and loaded into the computing system 500 using, for example, the removable storage unit 514, the media drive 510 or the communications interface 518. The control logic (in this example, software instructions or computer program code), when executed by the processor 502, causes the processor 502 to perform the functions of the invention as described herein.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of functions, it should be appreciated that different combinations of functions may be provided by alternative embodiments without departing from the scope of the appended claims. In this regard, for example, different combinations of functions than those explicitly described above are also contemplated as may be set forth in some of the appended claims. Although specific terms are employed herein, they are used in a generic and descriptive sense only and not for purposes of limitation.

What is claimed is:

1. A local artificial intelligence (AI) interaction and orchestration device, comprising:
a processor; and
a memory coupled to the processor, the memory storing instructions that, when executed by the processor, cause the processor to execute a smart agent configured to:
receive a task specification via one of: an input from a user, a sensor-generated signal, a programmatic event, or an application programming interface (API) call;
determine whether the task specified by the task specification is executable locally, based on the task specification, an execution capability of the local AI interaction and orchestration device, and an execution policy associated with the user;
when the task specified by the task specification is executable locally, the smart agent is to:
decompose the task specification into a plurality of subtasks; and
for each of the plurality of subtasks, select one or more local or remote AI agents, language models, or tool interfaces from a local capability registry, wherein the local capability registry is filtered according to enterprise access-control policies associated with the user; and
when the task specification is not executable locally, transmit the task specification to a remote computing platform executing a master agent, the master agent being configured to:
select, based on an enterprise directory, an authorized set of AI agents, language models, or tool interfaces available to the user for performing the task corresponding to the task specification;
activate the selected AI agents, language models, or tool interfaces to execute the task specified by the task specification; and
transmit an output associated with the executed task specification to the smart agent for user delivery.

2. The device of claim 1, wherein the master agent is further configured to provide the activated AI agents, language models, or tool interfaces with user-specific access credentials or access limitations derived from enterprise policies, to enforce privilege-restriction operations.

3. The device of claim 2, wherein the privilege-restriction operations performed by the master agent comprise generating ephemeral access tokens scoped to the user's enterprise privileges.

4. The device of claim 1, wherein the instructions further cause the processor to:
determine a task context for the task specification based on contextual data obtained from one or more of: local device signals, browser activity, user history, or system state,
wherein the task context is used by the smart agent to influence at least one of:
determining of whether the task specified by the task specification is executable locally;
decomposing of the task specification into the plurality of subtasks; or
selecting, for each of the plurality of subtasks, the one or more local or remote AI agents, language models, or tool interfaces from the local capability registry.

5. The device of claim 4, wherein the local device signals comprise one or more of:
local system data indicating hardware or software state of the local device;
browser activity including at least one of browser history, active webpage metadata, or user interaction patterns;
user history stored locally on the local AI interaction and orchestration device; or
capability indicators of the local device comprising processor availability, memory utilization, or execution restrictions.

6. The device of claim 4, wherein determining the task context further comprises:
monitoring at least one of: browser tabs, page content, active applications, locally running processes, or recency-weighted user interactions.

7. The device of claim 1, wherein the smart agent is further configured to:
obtain, for the plurality of subtasks, subtask outputs from the selected one or more local or remote AI agents, language models, or tool interfaces; and
aggregate the subtask outputs into a consolidated task result for presentation to the user.

8. The device of claim 7, wherein the consolidated task result comprises structured output annotated with provenance indicators identifying contributing AI agents, language models, or tool interfaces.

9. The device of claim 1, wherein, determining whether the task specification is executable locally, comprises:
computing a device-capability score based on at least one of: memory availability, processor utilization, neural-accelerator presence, or energy constraints.

10. The device of claim 1, wherein the master agent is further configured to:
determine whether the task specification requires multi-agent cooperation;
upon determining that the task specification requires multi-agent cooperation, decompose the task specification into a plurality of subtasks; and
orchestrate delegation of the subtasks to one or more backend AI agents.

11. The device of claim 1, wherein the local capability registry is dynamically updated based on changes to enterprise policy, newly available local models, or revoked access rights.

12. The device of claim 1, wherein the local capability registry comprises entries referencing AI agents, language models, or tool interfaces executable on the local device or remotely through enterprise-approved channels.

13. The device of claim 1, wherein the smart agent is further configured to classify incoming tasks into categories comprising: a workflow automation category, an information retrieval category, a generative response generation category, or a multi-agent reasoning category.

14. The device of claim 1, wherein the master agent is further configured to coordinate execution between on-premise servers and cloud-hosted AI agents based on enterprise routing policies.

15. A method for executing a task using a local artificial intelligence (AI) interaction and orchestration device, the method comprising:
receiving a task specification via one of: an input from a user, a sensor-generated signal, a programmatic event, or an application programming interface (API) call;
determining whether the task specified by the task specification is executable locally, based on the task specification, an execution capability of the local AI interaction and orchestration device, and an execution policy associated with the user;
when the task specified by the task specification is executable locally,
decomposing the task specification into a plurality of subtasks; and
for each of the plurality of subtasks, selecting one or more local or remote AI agents, language models, or tool interfaces from a local capability registry, wherein the local capability registry is filtered according to enterprise access-control policies associated with the user; and
when the task specification is not executable locally,
transmitting the task specification to a remote computing platform executing a master agent, the master agent being configured to:
select, based on an enterprise directory, an authorized set of AI agents, language models, or tool interfaces available to the user for performing the task corresponding to the task specification;
activate the selected AI agents, language models, or tool interfaces to execute the task specified by the task specification; and
transmit an output associated with the executed task specification to the smart agent for user delivery.

16. The method of claim 15, further comprising:
determining a task context for the task specification based on contextual data obtained from one or more of: local device signals, browser activity, user history, or system state,
wherein the task context is used by the smart agent to influence at least one of:
determining of whether the task specified by the task specification is executable locally;
decomposing of the task specification into the plurality of subtasks; or
selecting, for each of the plurality of subtasks, the one or more local or remote AI agents, language models, or tool interfaces from the local capability registry, and
wherein the local device signals comprise one or more of:
local system data indicating hardware or software state of the local device;
browser activity including at least one of browser history, active webpage metadata, or user interaction patterns;
user history stored locally on the local AI interaction and orchestration device; or
capability indicators of the local device comprising processor availability, memory utilization, or execution restrictions.

17. The method of claim 16, wherein determining the task context further comprises:
monitoring, by the smart agent, at least one of: browser tabs, page content, active applications, locally running processes, or recency-weighted user interactions.

18. The method of claim 15, further comprising:
obtaining, for the plurality of subtasks, subtask outputs from the selected one or more local or remote AI agents, language models, or tool interfaces; and
aggregating the subtask outputs into a consolidated task result for presentation to the user,
wherein the consolidated task result comprises structured output annotated with provenance indicators identifying contributing AI agents, language models, or tool interfaces.

19. The method of claim 1, wherein determining whether the task specification is executable locally comprises:
computing a device-capability score based on at least one of: memory availability, processor utilization, neural-accelerator presence, or energy constraints.

20. A non-transitory computer-readable medium storing computer-executable instructions for executing a task using a local artificial intelligence (AI) interaction and orchestration device, the computer-executable instructions configured for:
receiving a task specification via one of: an input from a user, a sensor-generated signal, a programmatic event, or an application programming interface (API) call;
determining whether the task specified by the task specification is executable locally, based on the task specification, an execution capability of the local AI interaction and orchestration device, and an execution policy associated with the user;
when the task specified by the task specification is executable locally,
decomposing the task specification into a plurality of subtasks; and
for each of the plurality of subtasks, selecting one or more local or remote AI agents, language models, or tool interfaces from a local capability registry, wherein the local capability registry is filtered according to enterprise access-control policies associated with the user; and
when the task specification is not executable locally,
transmitting the task specification to a remote computing platform executing a master agent, the master agent being configured to:
select, based on an enterprise directory, an authorized set of AI agents, language models, or tool interfaces available to the user for performing the task corresponding to the task specification;
activate the selected AI agents, language models, or tool interfaces to execute the task specified by the task specification; and
transmit an output associated with the executed task specification to the smart agent for user delivery.
